(19) United States
(12) Patent Application Publication
(10) Pub. No.: US 2010/0041283 A1
(43) Pub. Date: Feb. 18, 2010

(54) Electrical Contact With Biasing Device

(76) Inventors: Stephane Hernandez, Chaville (FR); Michel Aeschbacher, Saint-Prest (FR)

Correspondence Address: Harrington & Smith PC, 4 Research Drive, Suite 202, Shelton, CT, 06484, US

(21) Appl. No.: 12/085,801

(22) PCT Filed: Nov. 30, 2005
(86) PCT No.: PCT/FR2005/002988

§ 371 Date: May 22, 2009

(51) Int. Cl. H01R 13/11

(52) U.S. Cl. 439/851

(57) ABSTRACT

The subject of the invention is a contact element including a front contact part intended to cooperate with a complementary contact part of a complementary contact element, a part for holding the contact element in a connector case socket and a guiding boss, wherein the guiding boss consists of a tab folded from the front to the back of the electrical contact element and exhibiting a rounded nose.

The present invention concerns an electrical contact with a guiding device for insertion of the contact into a contact-bearing module.

Guiding devices used for electrical contacts are designed to assure the correct orientation of contacts in the sockets of contact-bearing modules or connector cases.

Document FR 2,869,161 describes an electrical contact cage that is inserted into a connector case socket and that is provided with a guiding device comprising at least one boss, made from cutting out and stamping a lateral wall of the contact cage to laterally extend beyond this cage, so as to create, by cooperating with a groove for free passage of the boss, a 360° orientation of the contact permitting it to be inserted into the socket in a single angular position.

This guiding device, positioned on a rear part of the cage, however, allows the contact to initially be inserted in a poor angular position.

Moreover, such a guiding device, made from cutting and stamping a boss that is crosswise relative to the direction of insertion of the contacts into the sockets of the connector cases receiving them, bears cutting edges that may damage the sealing rings positioned at the socket entrance, and through which the contacts must pass during their insertion into cases.

The object of the present invention is to create a contact element provided with a guiding device that does not cause damage and proposes for this purpose a contact element bearing a front contact part designed to cooperate with a complementary contact part of a complementary contact element, a part for holding the contact element in a connector case socket and a guiding boss, for which the guiding boss consists of a tab folded from the front to the back of the electrical contact element, and has a rounded nose.

More particularly, to prevent damage when the contact is extracted from its socket, on the folded tab, the free rear part of the folded tab is at least partially inserted into a recess in the holding part.

According to a particular embodiment of the invention within the scope of a female cage contact, the folded tab extends beyond the front of the cage so that the guiding device prevents an initial erroneous insertion of the contact element into its socket.

Other characteristics and advantages of the invention can be derived from the description that follows of non-limiting examples of embodiment of the invention, in reference to the drawings, which show:

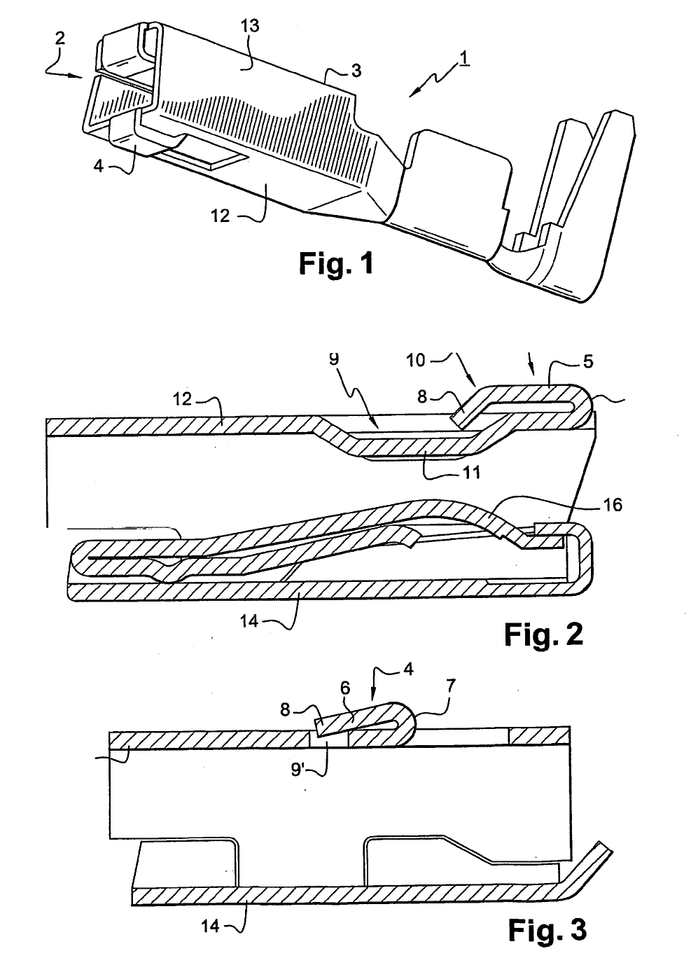

in FIG. 1: a perspective view of a first example of embodiment of the invention on a female contact element;

in FIG. 2: a sectional view of a front part of the contact element of FIG. 1;

in FIG. 3: a sectional view of a second example of embodiment of the invention on a holding part for a male contact element;

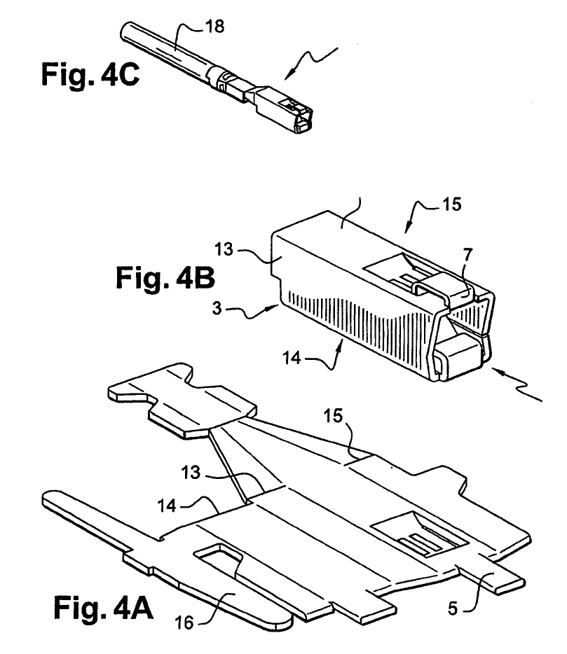

in FIGS. 4A, 4B, 4C: respectively, a flat view of a precut blank, a perspective view of the front part after folding of the blank, and an assembled view in perspective of the contact element of FIG. 1 connected to a cable;

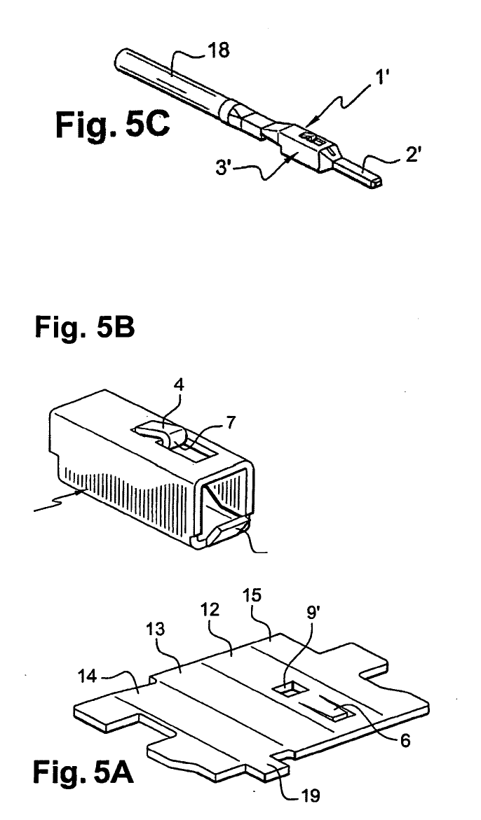

in FIGS. 5A, 5B, 5C: respectively, a flat view of a precut blank, a perspective view of a holding part after folding of the blank, and an assembled view in perspective of a male contact element connected to a cable and comprising the invention;

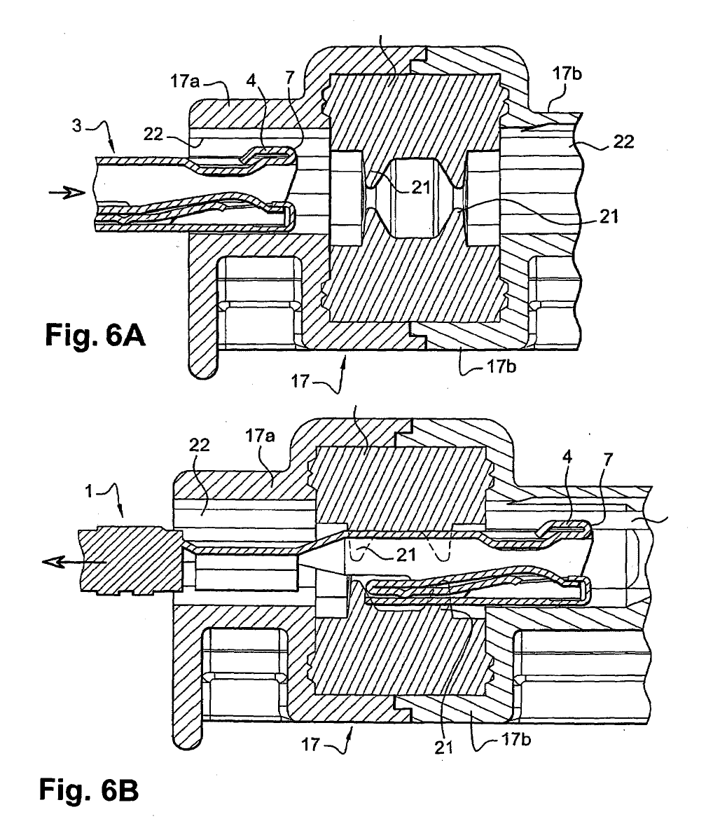

in FIGS. 6A and 6B: sectional views of an example of the connector case and a contact element according to the invention in the process of being inserted in FIG. 6A, and being extracted in FIG. 6B;

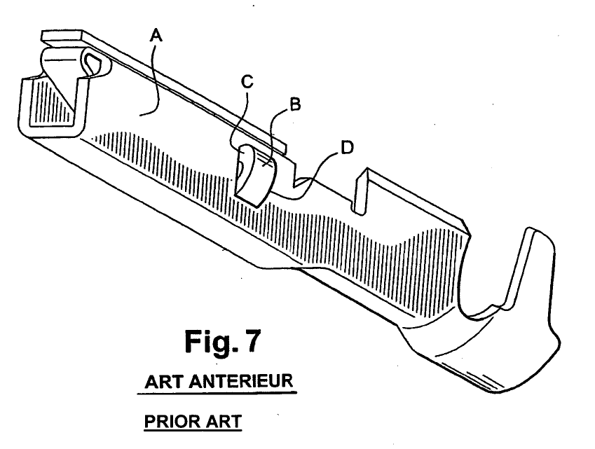

in FIG. 7, an example of embodiment of a contact according to the prior art.

The invention is particularly suited to an electrical contact element of the female electrical contact type 1, of which an assembled view is given in FIG. 4C, or to a male contact element 1′, of which an assembled view is given in FIG. 5C.

In the case of the female contact element, this element bears a contact front part 2 in the form of a cage incorporating a spring contact blade 16, shown in FIG. 2, designed to cooperate with a complementary contact part 2′, in the form of a terminal, of a complementary male electrical contact element 1′.

The cage consists of a part 3 for holding the contact element in a socket of connector case 17.

Such a female contact, in particular, is made in a single piece from a cut-out blank, shown in FIG. 4A, this blank then being folded to create the contact element.

According to the example, the contact element is designed to be crimped onto a cable 18 in a manner known in itself.

In the case of male contact element 1′ shown in an assembled view in FIG. 5C, this contact bears a contact front part 2′, in the form of a terminal designed to cooperate with a spring contact blade 16 positioned in the cage-shaped part of a complementary contact element 2 such as a female electrical contact element 1 described above.

In the traditional manner, the male contact element can be cut, folded or rolled and is covered with a cage, assembled onto the contact element, forming a part 3′ for holding the male contact in a socket of connector case 17.

The assembled cage is made from a cut-out blank shown in FIG. 5A; this blank is then folded and inserted onto contact terminal 2′.

According to the invention, the female contact element and the male contact element are provided with a guiding boss 4, made up of a tab 5, 6, folded from the front to the back of the electrical contact element and having a rounded nose 7.

FIG. 2 more particularly shows the embodiment of the boss according to the invention for a female contact element, while FIG. 3 more particularly shows an embodiment within the scope of an assembled cage designed to cover the central part of a male contact element.

It is possible, of course, to combine the embodiments if necessary.

In the example of FIG. 2, guiding boss 4 is made from a tab 5 extending beyond the front of the blank designed to make the female cage and, as shown in FIG. 4A, this tab is folded from the front to the back of the contact element in a rounded manner in order to create the rounded nose.

Advantageously, the rounded nose itself extends beyond the front of the cage once the tab is folded, so that, as soon as the contact element starts to be inserted into its socket, the operator can detect whether the contact is oriented in its correct position relative to the socket.

This detection results from the fact that advanced nose 7 butts against a wall of the socket that does not have a groove for free passage of the boss.

In the case of the female contact of FIG. 2, a free rear part 8 of the tab is inserted at least partially into a recess 9 made up here of a cut-out from holding part 3. According to the example shown, this cut-out results from stamping ceiling 11 of the cage, positioned facing spring contact blade 16, designed to guide complementary contact terminal 2′ when it is inserted into the female contact.

In this figure, the free rear part of the boss shown bears a flap 10 folded into said recess 9 consisting of a cut-out, the end of flap 10 being entirely received in recess 9 so that the flap constitutes a ramp designed to push aside a lip of the rear joint without damaging it during extraction of the contact from its socket, in order to prevent the edge from causing damage at the rear of the boss in the direction of extraction of the contact from the socket.

In the case of the male contact of FIG. 3, tab 6 is formed from a cut-out of a wall 12 of holding part 3 and its free rear part 8 is inserted at least partially into a recess 9′ made to receive this free rear part 8.

Thus, the free rear part of the folded tab of the male contact is encased in the body of the cage in order to prevent any risk of detaching the joint by the rear end of the tab making up the boss when the contact is removed from its socket.

These two modes of embodiment of the invention are each optimized as a function of their use.

In the case of the female contact, the frontal boss assures a precise positioning of the front of the contact in the socket, but unfortunately increases the quantity of material consumed.

However, this increase remains negligible relative to the surface of the blank designed to make the contact.

In the case of the male contact, the boss created by cutting out, and positioned towards the middle of wall 12, does not require the consumption of additional material on its part, which is particularly advantageous due to the small dimensions of the assembled cage.

FIGS. 4B and 5B, respectively, more particularly represent the parts of a female contact cage and an assembled cage relative to a male contact on which the bosses according to the invention are created.

In the case of assembled cage 3′ for the contact terminal element, a stud 19 positioned at the tip of the wall opposite the wall bearing boss 4 assures that the assembled cage is held and positioned on the contact element.

In both cases, tab 5 or 6 constitutes a longitudinal boss 4 and, in the case of the female contact, this boss 4 is positioned on a wall 12 opposite a wall 14 bearing spring contact blade 16 integrated into holding part 3.

FIGS. 6A and 6B illustrate the insertion and extraction of a female contact such as described above in a connector case 17 of which only a central part is shown.

Connector case 17, according to the example receives a joint 20 of the grommet type, provided with lips 21 designed to seal the back of the connector when applied onto cables 18 joined to contacts 1, 1′.

Grommet 20 is received between two case halves 17a, 17b, respectively making up the back and the front of connector case 17, as known in the prior art.

The sockets for receiving the contacts are provided with grooves 22 for the free passage of bosses 4.

During insertion of contacts 1 into the sockets, the front of the contacts pushes apart lips 21 of the grommet.

Due to the fact that, unlike the contact of the prior art A shown in FIG. 7, for which transverse bosses B bear sharp edges C, D in the insertion/extraction direction of the contacts into the sockets, bosses 4 of the contact according to the invention are longitudinal bosses provided with a rounded nose 7 and a free rear part pushed into a recess 9; these bosses do not risk damaging lips 21 either during insertion, according to FIG. 6A, or extraction, according to FIG. 6B.

The invention is not limited to the examples shown and, in particular, two bosses according to the invention can be provided on the lateral walls of cage 5 in the case of contacts with 180° polarization.

1. A contact element bearing a front contact part designed to cooperate with a complementary contact part of a complementary contact element, a part for holding the contact element in a socket of a connector case and a guiding boss, characterized in that guiding boss consists of a tab, folded from the front to the back of the electrical contact element, and has a rounded front.

2. The contact element according to claim 1, for which a free rear part of the tab is inserted at least partially into a recess of holding part.

3. The contact element according to claim 2, for which free rear part of tab bears a flap folded into said recess.

4. The contact element according to claim 2 for which recess results from stamping a ceiling for contact with a complementary contact part.

5. The contact element according to claim 1, for which contact element is a cage contact and for which nose of folded tab extends beyond the front of the cage.

6. The contact element according to claim 1, for which tab arises from a cut-out of a wall of holding part.

7. The contact element according to claim 1 for which tab constitutes a longitudinal boss positioned on a wall opposite a wall bearing a spring contact blade integrated in holding part.
